(19) United States
(12) Patent Application Publication
(10) Pub. No.: US 2006/0126090 A1
(43) Pub. Date: Jun. 15, 2006

(54) Printing system

(75) Inventor: Zhongming Shen, Sunnyvale, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONIKA MINOLTA SYSTEMS LABORATORY, INC.

(21) Appl. No.: 11/010,310

(22) Filed: Dec. 14, 2004

(51) Int. Cl. G06K 15/00

(52) U.S. Cl. 358/1.13; 358/1.15; 358/1.16

(57) ABSTRACT

The present application relates to a printing system of which crash of the spooler process can be recovered easily.

### FIELD

The present invention relates to a method, a system and an apparatus of printing and an apparatus producing a print job and software of printer driver.

### INTRODUCTION

By utilizing printers, users can print documents which the users produce by their personal computers (PC). In order to enable a system including a PC and a printer to print certain software so-called “print spooler” is installed in PC.

However, utilizing such print spooler exhibits certain drawback. If a spooler process conducted by the print spooler crashes when the users start printing, it is difficult for the users to recover the crash of the spooler process. Because the crash of the spooler process cannot be recovered even if users turn off the PC once and the restart the PC. In order to recover the spooler crash, high level skilled knowledge is required.

Therefore, it is desirable that the users can recover the crash of the spooler process easily even if the crash of the process occurs.

### SUMMARY

According to various embodiments, the present teachings can provide a printing system. The printing system can comprise a print job producing portion which can produce a print job. The printing system can comprise a print spooler which can store the print job produced by the print job producing portion and can conduct a spooler process. The printing system can comprise a detecting portion which can detect the crash of the spooler process. The printing system can comprise a spooler crash solving portion which can conduct a spooler crash solving process. The printing system can comprise a printing portion which can print according to the print job stored in the print spooler. If the detecting portion detects the crash of the spooler process, the spooler crash solving portion can trigger a spooler crash solving process.

If the detecting portion does not detect the crash of the spooler process, the spooler crash solving portion can make the spooler crash solving process hibernate during the printing by the printing portion. The printing system can comprise a displaying portion which can display instruction for user. And, the spooler crash solving process can be a process to show up a message box in the display portion to guide the user to recover the crash of the spooler process. The spooler crash solving process can be a process to remove the print job from the spooler automatically or manually.

### BRIEF DESCRIPTION OF THE DRAWINGS

FIG. 1 illustrates a figure of relationship among application software, printer driver and print spooler, according to certain embodiments.

FIG. 2 illustrates a block diagram of a printing system comprising a PC and a printer, according to certain embodiments.

FIG. 3 illustrates a flow chart for recovering a crash of a print spooler, according to certain embodiments.

### DESCRIPTION OF CERTAIN EMBODIMENTS

System and Apparatus

In certain embodiments, a printing system can comprise one or several PC (s) and/or server(s). In certain embodiments, the printing system can comprise one or several printer(s). In certain embodiments, the printing system can comprise network which connects the PC and/or the server with the printer.

In certain embodiments, the PC can comprise at least one of a hard disk, a memory, a network connecting portion, a displaying portion, a data input portion and a central processing unit (CPU) or a micro processing unit (MPU). Examples of the network connecting portion consistent with certain embodiments of the invention include, but not limited to, a local area network (LAN) adapter, a modem and a network card. Examples of the displaying portion consistent with certain embodiments of the invention include, but not limited to, a liquid crystal display (LCD), a Braun tube, a cathode ray tube (CRT) and a plasma display panel. Examples of the data input portion consistent with certain embodiments of the invention include, but not limited to, a keyboard, a mouse, a push button and a touch panel.

In certain embodiments, application software can be installed into the PC. In certain embodiments, the application software can be used to produce document data (including document, drawing, table, picture and/or photo and the like) which can be printed by the printer. Examples of the application software consistent with certain embodiments of the invention include, but not limited to, word processor software (e.g., Microsoft Word™ etc.), image processing software (e.g., Adobe Photoshop™ etc.), spread sheet software (e.g., Microsoft Excel™ etc) and viewer software (e.g., Acrobat Reader™ etc.).

In certain embodiments, software of printer driver can be installed into the PC. In certain embodiments, the printer driver can control the printer connected with the personal computer in which the printer driver is installed. In certain embodiments, the printer driver can produce a print job based on the document data produced by the application software. In certain embodiments, the print job can include the document data, information of kind of printer, information of kind of printing medium, information of size of paper, information of number of print(s), information of page(s) printed and so on. In certain embodiments, the printer driver can control transfer of the print job from the PC to the printer.

In certain embodiments, software of print spooler can be installed into the PC. In certain embodiments, the print spooler can conduct management process of printing, that is a spooler process. Such spooler process can involve retrieving location of correct printer driver, loading that printer driver, spooling high-level function calls into the print job, scheduling print job for printing, and so on. In certain embodiments, the software of the print spooler can start at system starting time and is available until either service is stopped or operating system (OS) shutdown. In certain embodiments, the application software and/or the printer driver can conduct the spooler process with the print spooler.

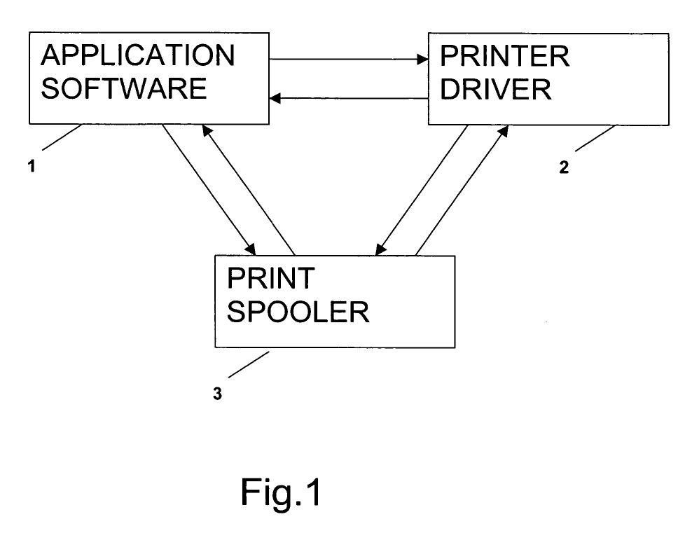

In certain embodiments, as illustrated in FIG. 1, relationship among the application software, the printer driver and the print spooler can be shown. In certain embodiments, application software 1 can produce the document data and send the document data to the printer driver 2. In certain embodiments, the printer driver 2 can produce the print job and send the print job to the print spooler 3. In certain embodiments. the printer driver 2 can provide device capability information (e.g., paper size, resolution, color mode of the printer and the like) to the application software 1. In certain embodiments, the print spooler 3 can store the print job sent from the printer driver. In certain embodiments, the print spooler 3 can send the print job to the printer driver 2 to send the print job from the PC to the printer. In certain embodiments, the communication between the application software 1 and the print spooler 3 can deal with general job information (e.g., printer status, print job status, port selection and the like).

Examples of the printer consistent with certain embodiments of the invention include, but not limited to, a laser beam printer, a multi function printer including copying function (MFP), an ink jet printer, a thermal printer (e.g., dye sublimation printers) and a silver halide printer. In certain embodiments, the printer can comprise at least one of a CPU or a MPU, a memory, a displaying portion, a data input portion and a network connecting portion. Examples of the network connecting portion, the displaying portion and the data input portion consistent with certain embodiments of the invention include, but not limited to, examples described in the above.

Examples of the network consistent with certain embodiments of the invention include, but not limited to, an internet, a LAN and a wide area network (WAN). The printer and the PC can be connected with a wire or be connected with wireless by using radio frequency (RF) and/or infrared (IR) transmission.

In certain embodiments, the printing system can comprise a print job producing portion, a print spooler, a detecting portion, a spooler crash solving portion, and a printing portion. In certain embodiments, the print job producing portion can produce the print job. In certain embodiments, the print spooler can store the print job produced by the print job producing portion and can conduct the spooler process. In certain embodiments, the detecting portion can detect the crash of the spooler process. In certain embodiments, the spooler crash solving portion can conduct a spooler crash solving process. In certain embodiments, the printing portion can print according to the print job stored in the print spooler. In certain embodiments, if the detecting portion detects the crash of the spooler process, the spooler crash solving portion can trigger the spooler crash solving process.

In certain embodiments, the print job producing portion of the printing system can produce the print job. In certain embodiments, the print job producing portion can be means for producing the print job. Examples of the print job producing portion consistent with certain embodiments of the invention include, but not limited to, a CPU or a MPU, a hard disk and a memory of the PC with the software of the printer driver. In certain embodiments, the print job producing portion can produce the print job based on the document data produced by the application software.

In certain embodiments, the print spooler can store the print job produced by the print job producing portion and can conduct the spooler process. In certain embodiments, the print spooler can be means for storing the print job. In certain embodiments, the print spooler can be means for conducting the spooler process. Examples of the print spooler consistent with certain embodiments of the invention include, but not limited to, a CPU or a MPU, a hard disk and a memory of the PC with the software of the print spooler. In certain embodiments, the print job can be stored temporally in the hard disk or the memory under the operation of the software of the print spooler. In certain embodiments, the spooler process can be conducted by the application software and/or the printer driver with the print spooler.

In certain embodiments, the detecting portion can detect the crash of the spooler process. In certain embodiments, the detecting portion can be means for detecting the crash of the spooler process. In certain embodiments, when the printer driver generates the print job, if the printer driver tries to access an invalid memory, the printer driver will crash and further cause the crash of the spooler process. In certain embodiments, if the application software crashes, it may cause the crash of the spooler process. In certain embodiments, on Microsoft Windows™ environment, OS can detect the crash of the spooler process automatically and some message can be displayed or some events can occur to notify the crash of the spooler process to the user or the PC (or some software in the PC). Examples of the detecting portion consistent with certain embodiments of the invention include, but not limited to, a CPU or a MPU of the PC.

In certain embodiments, the printing system can comprise the displaying portion. If the printing system comprises the PC, the displaying portion can be the displaying portion of the PC. If the printing system comprises the printer, the displaying portion can be the displaying portion of the printer. Examples of the displaying portion consistent with certain embodiments of the invention include, but not limited to, examples described in the above.

In certain embodiments, the spooler crash solving portion can conduct a spooler crash solving process. In certain embodiments, the spooler crash solving portion can be means for conducting the spooler crash solving process. Examples of the spooler crash solving portion consistent with certain embodiments of the invention include, but not limited to, a CPU or a MPU, a hard disk and a memory of the PC with the software of the printer driver. In certain embodiments, the spooler crash solving portion can make the spooler crash solving process hibernate unless the detecting portion detects the crash of the spooler process. In certain embodiments, the spooler crash solving portion can trigger the spooler crash solving process if the detecting portion detects the crash of the spooler process.

In certain embodiments, the spooler crash solving process can include any process which can recover the crash of the spooler process.

In certain embodiments, the spooler crash solving process can be a process to show up a message box in the display portion to guide the user to recover the crash of the spooler process. In certain embodiments, the user can conduct recovering operation of the crash of the spooler process by inputting instruction from the data input portion of the PC or the data input portion of the printer based on the contents of the message box. In certain embodiments, when Microsoft Windows™ is used as OS of the PC, if the crash of the spooler process occurs in the middle of conducting the print job, in the most cases, the spooler process can be stopped to prevent from printing. Because the print job is still in a queue of the print spooler, the user has to remove the queue so that the crash of the spooler will not happen anymore and the crash of the spooler process is recovered. In certain embodiments. the message box can include a message of “Starting the spooler process manually and deleting the print job from the queue of the print spooler immediately (quick enough to avoid to try to restart the print job and crash again).” and the like. In certain embodiments, the message box can include a message of “Without starting the spooler process, finding the file of the print spooler and deleting the print job before restarting of the spooler process” and the like.

In certain embodiments, the spooler crash solving process can be a process to remove the print job from the print spooler automatically or manually.

In certain embodiments, the PC can comprise the print job producing portion, the print spooler, the detecting portion, the spooler crash solving portion.

In certain embodiments, the printing portion can print according to the print job produced by the print job producing portion and stored in the print spooler. In certain embodiments, the printing portion can be means for printing. Examples of the printing portion consistent with certain embodiments of the invention include, but not limited to, a printing unit of the printer and a printing engine of the printer.

In certain embodiments, the printer can comprise the printing portion.

In certain embodiments, a print job producing apparatus can comprise the print job producing portion, the print spooler, the detecting portion, the spooler crash solving portion and the network connecting portion. Examples of the print job producing apparatus consistent with certain embodiments of the invention include, but not limited to, a PC in which the software of the print spooler and the software of the printer driver are installed. In certain embodiments, the application software can be installed in the PC which is the print job producing apparatus.

In certain embodiments, the network connecting portion can transfer the print job from the print job producing apparatus to the print spooler to the printer. In certain embodiments, the network connecting portion can be means for transferring the print job to the printer.

Examples of the print job producing portion, the print spooler, the detecting portion, the spooler crash solving portion and the network connecting portion consistent with certain embodiments of the invention include, but not limited to, examples described in the above.

Method

In certain embodiments, the user can produce the document data by utilizing the application software on the PC.

If the user wants to print the document data by the printer, the user can instruct the printer to start printing by inputting operation from the data input portion of the PC.

In certain embodiments, the printer driver can produce the print job based on the document data automatically after the user instructs the PC to start printing. In certain embodiments, the user can produce the print job by utilizing the printer driver and inputting the condition of the print job from the data input portion of the PC.

In certain embodiments, the print spooler can store the print job produced by the printer driver and can conduct a spooler process. In certain embodiments, the spooler process can be conducted by the application software and/or the printer driver with the print spooler.

In certain embodiments, when the user instructs the printer to start printing from the PC, it can be detected whether the crash of the spooler process occurs or not.

In certain embodiments, if the crash of the spooler process is not detected, the spooler crash solving process can be made hibernate during the printing by the printing portion. In certain embodiments, if the crash of the spooler is not detected, the print job can be sent from the print spooler to the printer driver and can be sent from the printer driver to the printer under the management of the print spooler. Then, the document data can be printed by the printer based on the print job sent by the printer driver.

In certain embodiments, if the crash of the spooler process is detected, the spooler crash solving process can be triggered.

In certain embodiments, the spooler crash solving process can be a process to show up the message box in the displaying portion to guide the user to recover the crash of the spooler process. According to the contents displayed in the message box, the user can conduct the recover process of the crash of the spooler by inputting some instruction from the data input portion of the personal computer or the printer. In certain embodiments. the message box can include a message of “Starting the spooler process manually and deleting the print job from the queue of the print spooler immediately, that is deleting the print job quick enough to avoid to try to restart the print job and crash again” and the like. In certain embodiments, the message box can include a message of “Without starting the print spooler, finding the file of the print spooler and deleting the print job before restarting of the spooler process” and the like. After the user conducts the recovering process based on the contents of the message box, it can be detected whether there is still the crash of the spooler process or not. If it is detected that there is still the crash of the spooler process, the spooler crash solving process again can be triggered again. If it is not detected that there is still the crash of the spooler process, the print job can be sent from the print spooler to the printer driver and can be sent from the printer driver to the printer for priority.

In certain embodiments, the spooler crash solving process can be a process to remove the print job from the print spooler automatically. After removing the print job, if there is not any other print job in the print spooler, the printer can stop printing. After removing the print job, if there is another print job in the print spooler, it can be detected whether there is still the crash of the spooler process or not. If it is not detected that there is still the crash of the spooler process, the another print job can be sent from the print spooler to the printer driver and can be sent from the printer driver to the printer for printing.

In certain embodiments, if there are some kinds of the spooler crash solving process, the user can select the spooler crash solving process by inputting instruction from the data input portion of the PC or the printer.

Software

In certain embodiments, the software of the printer driver can conduct the spooler process and the spooler crash solving process. In certain embodiments, if the crash of the spooler process is detected by the PC, the spooler crash solving process can be triggered by the printer driver.

In certain embodiments, the software of the printer driver can be installed in the PC connected with the printer. The software of the printer driver can be installed into conventional printing system comprising the PC and the printer.

In certain embodiments, the software of the printer driver can be recorded onto removable data recording media. Examples of removable data recording media include, but are not limited to, digital memory cards, compact discs (e.g., CD-R, CD-RW, etc.), and digital versatile discs (e.g., DVD-R, DVD−RW, DVD+RW, etc.). Various types of digital memory cards compatible with certain embodiments of the invention include, but are not limited to, secure digital (SD) memory cards, Compact Flash™, Smart Media™, Memory Stick™, and the like.

In certain embodiments, the software of the printer driver can be delivered through the network (e.g., LAN, WAN, internet and so on).

### EXAMPLE

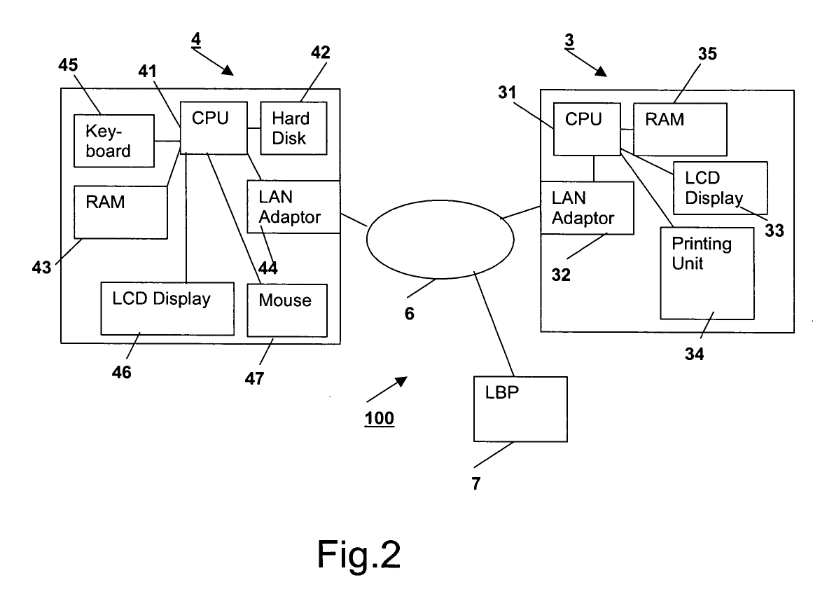

In certain embodiments, as illustrated in FIG. 2, the printing system 100 can comprise a PC 4, a laser beam printer (LBP) 3, a second LBP 7 and a LAN 6 connecting the PC 4 with the LBP 3.

In certain embodiments, as illustrated in FIG.2, the PC 4 can comprise a print job producing portion (e.g., a CPU 41, a hard disk 42 and a RAM 43 with software of the printer driver installed in the PC 4), a print spooler (e.g., the CPU 41, the hard disk 42 and the RAM 43 with software of print spooler installed in the PC 4), a detecting portion (e.g., the CPU 41), a spooler crash solving portion (e.g., the CPU 41, the hard disk 42 and the RAM 43 with the software of the printer driver installed in the PC 4) a displaying portion (e.g., a LCD display 46), a network connecting portion (e.g., a LAN adaptor 44) and a data input portion (e.g., a keyboard 45 and a mouse 47). In certain embodiments, application software (e.g., Microsoft Word etc.), software of the printer driver and software of the print spooler can be installed in the PC 4.

In certain embodiments, the LBP 3 can comprise a printing portion (e.g., a printing unit 34), a displaying portion (e.g., a LCD display 33), a RAM 35, a network connecting portion (e.g., a LAN adaptor 32) and a CPU 31.

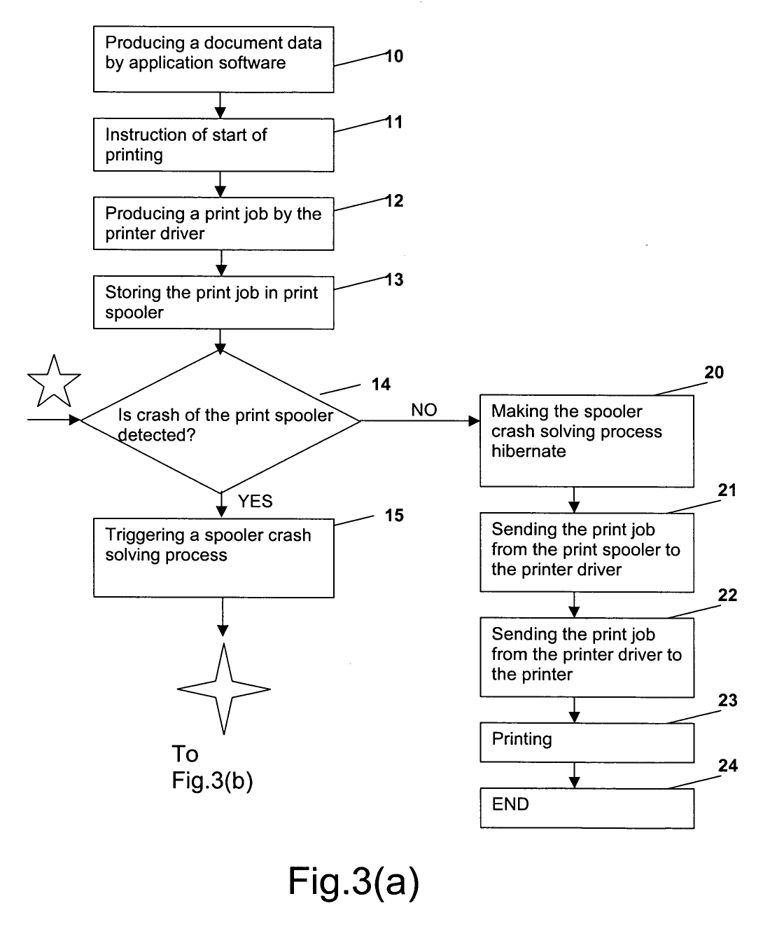

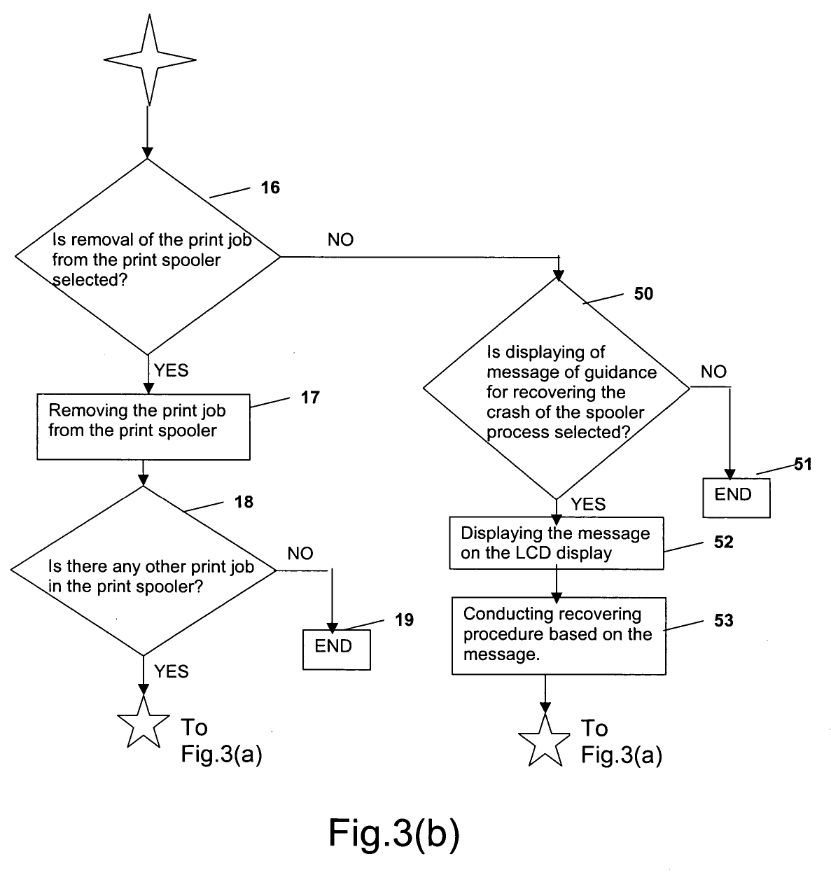

In certain embodiments, as illustrated in FIGS. 2 and 3(a), the user can produce the document data by using application software such as Microsoft Word and by inputting data from the keyboard 45 or the mouse 47 to the PC 4. (step 10 of FIG. 3(a)) If the user wants to print the document data by the LBP 3, the user can instruct the LBP 3 to start printing from the keyboard 45 or the mouse 47 of the PC 4. (step 11 of FIG. 3(a)) In certain embodiments, before or after the instruction of start of the printing, the software of the printer driver installed in the PC 4 can produce the print job with the CPU 41 based on the document data automatically according to the user's instruction. (step 12 of FIG. 3(a)) In certain embodiments, the print job can comprise the document data, information of kind of printer (e.g., LBP 3), information of kind of printing medium (e.g., normal paper) information of the number of print (e.g., 1 sheet), information of paper size (e.g., letter size), information of page (e.g., page 1-end page) and the like.

In certain embodiments, the print spooler can store the print job temporally produced by the printer driver. (step 13 of FIG. 3(a)) In certain embodiments, the spooler process can be conducted by the print spooler. In certain embodiments, the spooler process can be conducted by the application software and/or the printer driver with the print spooler.

In certain embodiments, the CPU 41 can judge whether the crash of the spooler process is detected or not. (step 14 of FIG. 3(a)) In certain embodiments, if the CPU 41 does not detect the crash of the spooler process, the printer driver can make the spooler crash solving process hibernate during the printing by the LBP 3. (step 20 of FIG. 3(a)) In certain embodiments, if the CPU 41 does not detect the crash of the spooler, the print job can be sent from the print spooler to the printer driver. (step 21 of FIG. 3(a)) Then, the printer driver can send the print job from the PC 4 to the LBP 3 through the LAN adaptor 44 of the PC 4, the LAN 6, and the LAN adaptor 32 of the LBP 3. (step 22 of FIG. 3(a)) Then, the document data can be printed by the printing unit 34 of the LBP 3 based on the print job sent from the PC 3. (step 23 of FIG. 3(a)) In certain embodiments, if the CPU 41 of the PC 4 detects the crash of the spooler process, the printer driver can trigger the spooler crash solving process. (step 15 of FIG. 3(a)) In certain embodiments, according to the algorithm of the spooler crash solving process of the printer driver, a message, “SPOOLER CRASH HAS OCCURRED. DOES REMOVE THE PRINT JOB FROM THE PRINT SPOOLER? YES or NO”, can be displayed on the LCD display 46 of the PC 4. (step 16 of FIG. 3(B)) In certain embodiments, if the user chooses “YES” from the keyboard 45 or the mouse 47, the print job can be removed from the print spooler. (step 17 of FIG. 3(b)) Then, the CPU 41 can detect whether there is any other print job in the print spooler or not. (step 18 of FIG. 3(b)) If the CPU 41 detects there is any other print job in the print spooler, the CPU 41 can detect again whether the crash of the spooler process has occurred or not. (step 14 of FIG. 3(a)) If the CPU 41 detects no print job in the print spooler, the PC 4 can send the instruction to stop printing to the LBP 3 through the LAN 6 and the LBP 3 can stop printing. (step 19 of FIG. 3(b)) If the user chooses “NO” from the keyboard 45 or the mouse 47, according to the algorithm of the spooler crash solving process of the printer driver, another message, “DO YOU WANT TO RECOVER THE CRASH OF THE SPOOLER PROCESS ACCORDING TO THE DISPLAYED GUIDANCE? YES or NO”, can be displayed on the LCD display 46 of the PC 4. (step 50 of FIG. 3(b)).

If the user chooses “NO” from the keyboard 45 or the mouse 47, the PC 4 can send the instruction to stop printing to the LBP 3 through the LAN 6 and the LBP 3 can stop printing. (step 51 of FIG. 3(b)) If the user chooses “YES” from the keyboard 45 or the mouse 47, according to the algorithm of the spooler crash solving process of the printer driver, a message box can be shown up in the LCD display 46 of the PC 4 and/or the LCD display 33 of the LBP. (step 52 of the FIG. 3(b)) In certain embodiments, the message box can include the information to guide the user to recover the crash of the spooler process. In certain embodiments, the message box can include the message of “Without starting the spooler process, please find a file of the print spooler (file name is “PSPL”) which is in the folder of “ABC” of “C” drive. Then, please delete the print job in the file of the “PSPL”. After that, please restart spooler process by clicking the following “OK” button.” According to the contents displayed in the message box, the user can recover the crash of the spooler process by inputting some instruction from the keyboard 45 or the mouse 47 of the PC 4. (step 53 of FIG. 3(b)) After the user conducts the recovering procedure based on the contents of the message box, the CPU 41 can detect again whether there is still the crash of the spooler process or not. (step 14 of FIG. 3(a)) If CPU 41 does not detect the crash of the spooler process, the LBP 3 can prints according to the print job.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A printing system, comprising:
a print job producing portion which produces a print job,
a print spooler which stores the print job produced by the print job producing portion and conducts a spooler process,
a detecting portion which detects a crash of the spooler process,
a spooler crash solving portion which conducts a spooler crash solving process, and
a printing portion which prints according to the print job stored in the print spooler, and
wherein, if the detecting portion detects the crash of the spooler process, the spooler crash solving portion triggers the spooler crash solving process.

2. The printing system of claim 1,
wherein if the detecting portion does not detect the crash of the spooler process, the spooler crash solving portion makes the spooler crash solving process hibernate during the printing by the printing portion.

3. The printing system of claim 1, further comprising
a displaying portion which displays instruction for user, and
wherein the spooler crash solving process is a process to show up a message box in the display portion to guide the user to recover the crash of the spooler process.

4. The printing system of claim 1,
wherein the spooler crash solving process is a process to remove the print job from the print spooler.

5. A print job producing apparatus, comprising:
a print job producing portion which produces a print job,
a print spooler which stores the print job produced by the print job producing portion and conducts a spooler process,
a detecting portion which detects a crash of the spooler process,
a spooler crash solving portion which conducts a spooler crash solving process, and
a network connecting portion which transfers the print job stored in the print spooler to a printer which is connected with the print job producing apparatus, and
wherein, if the detecting portion detects the crash of the spooler process, the spooler crash solving portion triggers the spooler crash solving process.

6. A software of a printer driver which is installed in a personal computer including a print spooler,
wherein the printer driver conducts a spooler process with a print spooler and conducts a spooler crash solving process and
wherein if a crash of the spooler process is detected by the personal computer, a spooler crash solving process is triggered by the printer driver.

7. A printing system, comprising:
means for producing a print job,
means for storing the print job produced by the print job producing means,
means for conducting a spooler process,
means for detecting a crash of the spooler process conducted by the spooler process conducting means,
means for conducting a spooler crash solving process, and
means for printing according to the print job stored in the print job storing means, and
wherein, if the detecting means detects the crash of the spooler process, the spooler crash solving process conducting means triggers the spooler crash solving process.

8. A print job producing apparatus, comprising:
means for producing a print job,
means for storing the print job produced by the print job producing means,
means for conducting a spooler process,
means for detecting a crash of the spooler process conducted by the spooler process conducting means,
means for conducting a spooler crash solving process, and
means for transferring the print job stored in the print job storing means to a printer which is connected with the print job producing apparatus, and
wherein, if the detecting means detects the crash of the spooler process, the spooler crash solving process conducting means triggers the spooler crash solving process.
